(19) United States
(12) Patent Application Publication
(10) Pub. No.: US 2014/0188829 A1
(43) Pub. Date: Jul. 3, 2014

(54) TECHNOLOGIES FOR PROVIDING DEFERRED ERROR RECORDS TO AN ERROR HANDLER

(71) Applicants: Narayan Ranganathan, Portland, OR (US); Mahesh Natu, San Jose, CA (US); Mohan J. Kumar, Aloha, OR (US); Sarathy Jayakumar, Portland, OR (US)

(72) Inventors: Narayan Ranganathan, Portland, OR (US); Mahesh Natu, San Jose, CA (US); Mohan J. Kumar, Aloha, OR (US); Sarathy Jayakumar, Portland, OR (US)

(21) Appl. No.: 13/728,451

(22) Filed: Dec. 27, 2012

(51) Int. Cl. G06F 17/30

(52) U.S. Cl. CPC G06F 17/30289
USPC 707/705

(57) ABSTRACT

Technologies to generate an error record are described herein. A method includes performing a scan of one or more error logs to identify a source of data in response to an attempt to access the data, determining whether an amount of time to complete the scan will exceed a threshold value, and generating a notice that the error record will be deferred based on the determination. A system includes a data collector to scan one or more error logs to identify a source of data in response to an attempt to access the data, a controller to determine whether an amount of time to scan the error logs to identify the source of data will exceed a threshold value, and a signal generator to generate a signal indicating that the error record is to be deferred based on the determination.

### FIELD OF THE DISCLOSURE

This disclosure relates generally to method of generating an error record in a computing system and, more particularly, to technologies for providing deferred error records to an error handler.

### BACKGROUND

Servers in mission critical segments of a computer system are required to operate with limited or no downtime. To limit server downtime, reliability and serviceability are built into computer system platforms at many levels, starting with the hardware platform that includes the system processor, memory and interconnect. Though existing computer systems have many components protected by Error Correction Codes (ECC), such systems are still susceptible to single-bit and multi-bit errors, some of which can be left uncorrected by hardware. Machine Check Exception (MCE) and Corrected Machine Check Interrupt (CMCI) are two hardware signaling mechanisms used to report such uncorrected errors to system software. Regardless of the error signaling mechanism used, it is critical that the computer system firmware/software get accurate and pertinent error information (e.g., information about the Field Replaceable Unit (FRU) responsible for the error) in order to perform appropriate serviceability action(s) and to limit downtime in mission critical environments. The FRU can include an individual processor in a microprocessor or dual processor, an individual memory dual in-line memory module in a memory sub-system, a memory buffer board, a peripheral component interconnect express (PCIe) switch, a node-controller device, a PCIe, an end point device such as a network storage device, etc.

Current computer system platforms provide error containment features such as data poisoning. In such platforms, when an uncorrectable data error is detected, hardware tags the data with a tag indicating that the data is corrupt/poison. Error signaling to inform the operating system/virtual machine manager (OS/VMM) when poisoned data has been accessed by, for example, a software application, can then be performed by one or more of the system platform levels (e.g., hardware, firmware). In response to the error signaling, appropriate action can be taken to remedy the error. Thus, an uncorrectable error does not bring down the system platform (i.e., signal a fatal machine check to the operating system/virtual machine manager (OS/VMM)), as would occur in systems lacking such error containment features. However, these error containment features can cause the error signaling to be postponed until the corrupted/poisoned datum is actually consumed by a software application running on the processor. As a result, there is typically a delay intervening between the time at which the poisoned data was first tagged and the time of consumption of the poison data. The separation of time between the poison/tagging of the data and the time of data consumption with the possibility of significant delay between the two can, in some instances, render platform software agents unable to accurately identify the error source and thereby negatively impact platform serviceability. Some error containment systems create an error record (“an enhanced error record”) that can be enhanced to identify the source of poisoned data in the system. In some examples the enhanced error record may be created by tracking all instances when hardware introduces the poisoned data into the system. Such error containment systems use these tracked instances to identify the source of the poison data, generate an error signal when the poison data gets consumed by a software application (e.g., a load operation performed by a software application targets the poisoned data) and create the enhanced error record for use by an error handler.

### BRIEF DESCRIPTION OF THE DRAWINGS

FIG. 1 is block diagram of an example computing system having an example error record generator to provide an error record on a deferred basis.

FIG. 2 illustrates a block diagram of example components used to implement the operations performed by the example error record generator of FIGS. 1 and 2.

FIG. 3 illustrates an example partial enhanced error record generated by the example first error record generator of the example system of FIG. 1.

FIG. 4 illustrates an example complete enhanced error record generated by the example first and/or second error record generators of the example system of FIG. 1

FIG. 5 illustrates an example error log directory structure that can be used to store and index the example partial and complete error records of FIGS. 3 and 4.

FIG. 6 illustrates a method used by the example system of FIG. 1 to generate the example partial enhanced error record and the example complete enhanced error record of FIGS. 3 and 4 on a deferred basis.

FIG. 7 is a block diagram of an example processing system that may execute the example machine readable instructions of FIG. 6 to implement the example analyzer and the example code generator of FIG. 1.

### DETAILED DESCRIPTION

Some computer system server platforms use platform firmware (e.g., System Management Mode (SMM)) firmware to track instances in which system hardware, such as a field replaceable unit (“FRU”), introduces poison data into the computer system. An SMM capable of performing such poison data tracking is able to generate an enhanced set of error data. The enhanced set of error data is enhanced to include information identifying the source of an uncorrected error that caused the poison data to be generated (e.g., the FRU that introduced the poison data). In operation, when a system hardware error detector determines that a system software application hosted by the operating system/virtual machine manager (OS/VMM) has accessed the poison data, it interrupts the OS/VMM and transfers system control to the SMM. The SMM responds by collecting information needed to construct the set of error data (an “enhanced error record”) while the execution of the OS/VMM system is suspended. To avoid undesirable impact to the operation of the OS/VMM, the duration of the interrupt is limited to a threshold amount of time (e.g., a maximum duration of, for example, 190 micro seconds). As a result, the SMM is required to collect the necessary information and construct the enhanced error record before reaching the prescribed threshold of time. However, the time needed to perform these actions and construct the enhanced error record may exceed the prescribed threshold. When the prescribed time limit is insufficient to construct an enhanced error record, the SMM may provide an inferior error record (e.g., a partial enhanced error record) or, in some cases, no error record at all. Example methods and systems disclosed herein extend the prescribed threshold of time allotted to an SMM to construct an enhanced error record that identifies the FRU responsible for causing poisoned data to be introduced into the system.

In some examples, methods and systems determine that an amount of time to construct an error record associated with access of poison data by a computer system component will exceed a threshold value and will notify an error record handler that the error record is to be deferred. The error record is enhanced to identify another system component that generated the poison data. In some examples, a partial version of the enhanced error record (“partial enhanced error record”) is created and then supplemented with additional information to thereby construct a “complete enhanced error record.” In some examples, the partial error record can include information that identifies a time at which the complete error record will be constructed and available for use by the error handler.

In some examples, an error record generator notifies the error record handler that the error record is to be delayed by transmitting a first signal that identifies a time at which the error record will be available and a location at which the error record is stored. In some examples, the error record generator transmits a second signal to the error record handler when the error record is available for use.

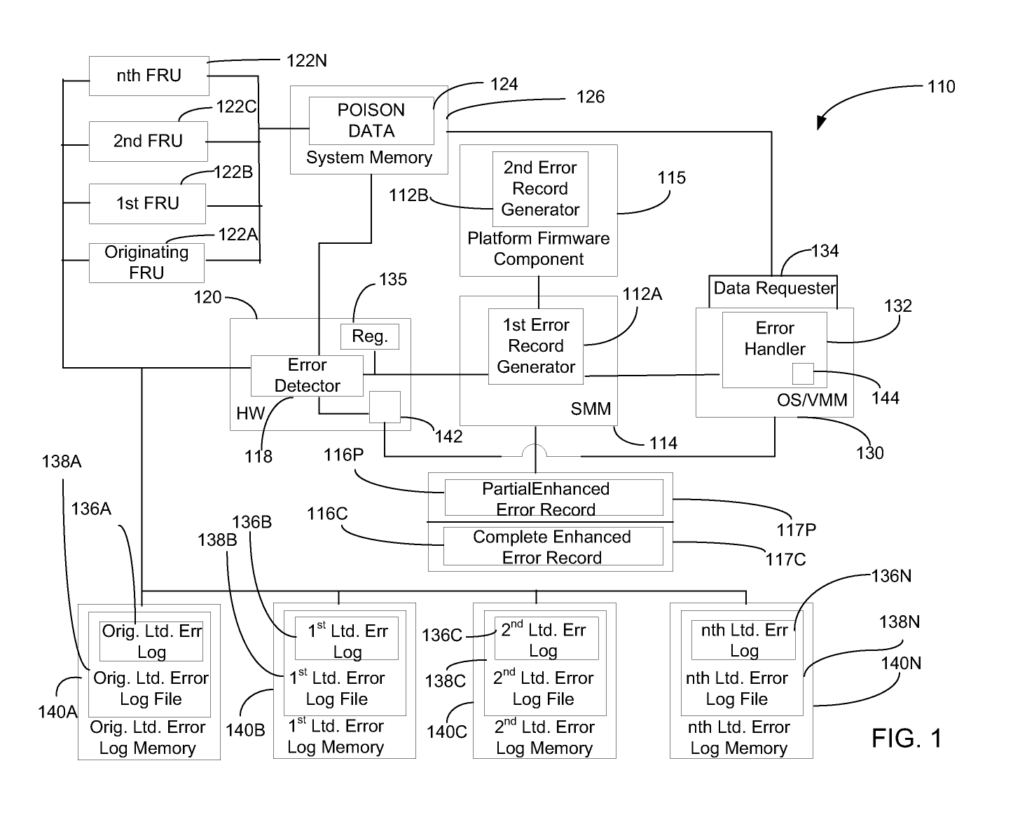

FIG. 1 illustrates a block diagram of an example system 110 having an example first error record generator 112A, an example second error record generator 112B, an example first system management mode component (SMM) 114, an example platform firmware component 115, an example enhanced error record having a partial enhanced error record 116P and a complete enhanced error record 116C stored in an example partial enhanced error record memory 117P and an example complete enhanced error record 117C, respectively. FIG. 1 also includes an example error detector 118, an example system hardware platform 120, and a set of example field replaceable units FRUs including an example originating FRU 122A, an example first FRU 122B, an example second FRU 122C, and an example nth FRU 122N, etc. In some examples, the SMM 114 also includes an error record handler. In operation, the originating FRU 122A experiences an uncorrected error that results in the generation of an example original corrupt data 124 and causes the example original corrupt data 124 to be placed into an example system memory 126 and tagged specially as being ‘poisoned’ (hereafter referred to as the “poison data 124”). The example system 110 also includes an OS/VMM 130, an error handler 132, and a data requester 134. In some examples, the example first error record generator 112A operates as part of the example SMM 114 and generates the example complete enhanced error record 116C in response to an error signal supplied by the example error detector 118. In some examples, the error detector 118 is associated with the system hardware component 120 which may be implemented using a processor with integrated memory example controller and I/O example controller, including PCIe root ports and interconnects (e.g., QPI, PCIe, high-speed memory link). In some examples, after the poison data 124 is placed into the system memory 126, one or more of the first FRU 122B, the second FRU 122C, the nth FRU 122N, etc., subsequently accesses the first memory 126 to obtain the poison data 124A.

In some examples, the data requester 134, which may be implementing using a software application hosted by the OS/VMM 130, attempts to access the poison data 124 stored in the example system memory 126. The example error detector 118 detects the attempted memory access, supplies the error signal to the example first error record generator 112A, and temporarily suspends operation of the example OS/VMM 130. The example first error record generator 112A responds to the error signal by collecting information needed to generate the example complete enhanced error record 116C while the example OS/VMM 130 is halted. The example first error record generator 112A then supplies the example complete enhanced error record 116C to the example error handler 132. The example error handler 132 uses the example complete enhanced error record 116C to perform any number of action(s) needed to correct the error including, for example, terminating the operation of the example data requester 134 and avoiding further use of the example originating FRU 122A responsible for generating the example poison data 124. Once the poison data 124 is tagged, the tag thereafter remains attached to the example poison data 124 to alert system hardware devices (e.g., the first FRU 122B, the second FRU 122C, the nth FRU 122N, the data requester 134, etc.) that subsequently access (or otherwise consume) the example poison data 124 that the example poison data 124 is corrupt.

Referring still to FIG. 1, in some examples, when the example data requester 134 attempts to consume the example poison data 124 at the system memory 126, the example first error record generator 112A constructs the example complete enhanced error record 116C while the example OS/VMM 130 is halted. The example first error record generator 112A constructs the example complete enhanced error record 116C using, for example, information collected from a set of example hardware registers 135 and information from a set of example limited error logs including an example originating limited error log 136A, an example first limited error log 136B, an example second limited error log 136C, an example nth limited error log 136N, etc., each located in a respective one of a set of example error logs including an example originating limited error log file 138A, an example first limited error log file 138B, an example second limited error log file 138C, and an example nth limited error log file 138N, etc. The example limited error log files 138A, 138B, 138C, . . . , 138N are each stored in a respective one of a set of example error log memories including an example originating limited error log memory 140A, an example first limited error log memory 140B, an example second limited error log memory 140C, and an example nth error log memory 140N, etc., as described in greater detail below. In some examples, the registers 135 se conventional can include machine check banks and other internal registers such as configuration space registers that are, in some cases, accessible only to the example SMM 114. The example first error record generator 112A stores the example complete enhanced error record 116C in the example complete enhanced error record memory 117C. In some examples, the example complete enhanced error record 116C is enhanced as compared to conventional error records in that it contains information sufficient to identify the example originating FRU 122A. In some examples, the enhanced information can identify the example originating FRU 124 corresponding to a system physical address (e.g., socket ID, memory example controller ID, channel number, DIMM number, etc.). Conventional error records (i.e., one that has not been enhanced) on the other hand, might only include the system physical address.

Upon placing the example complete enhanced error record 116C into the example complete enhanced error record memory 117C, the example first error record generator 112A supplies an example first signal to the example error handler 132. In some examples, the example first signal supplied to the example error handler 132 identifies the example complete enhanced error record memory 117C in which the example complete enhanced error record 116C is stored. The example error handler 132 responds to the example first signal by retrieving the example complete enhanced error record 116C from the example complete enhanced error record memory 117C for use in taking action(s) needed to resolve the uncorrected error associated with the original poison data 124. In some examples, the action(s) may include replacing the example originating FRU 122A responsible for the error, terminating operation of the data requestor 134 and/or avoiding further use of the example originating FRU 122A.

As described above, in some examples, before being accessed by the example data requester 134, one or more other system devices (e.g., the example first FRU 122B, the example second FRU 122C, the example nth FRU 122N, etc.) access the example poison data 124 located in the example system memory 126. In some examples, each of the example first FRU 122B, the example second FRU 122C, the example nth FRU 112N, etc., upon accessing the example poison data 124, uses conventional error assessment circuitry to determine the severity of the error caused by the access. Provided that the severity of the error is low (i.e., will have little or no adverse impact on the operation of the example system 110), the example error detector 118 and/or the requesting example FRU (e.g., the example first FRU 122B, the example second FRU 122C, . . . , the example nth FRU 122N, etc.) may use conventional methods to create and log a respective one of the example limited error logs 136A, 136B, 136C, . . . , 136N associated with each respective data request. For example, poison data may be extracted from an FRU (such as, for example, a memory buffer) and used to display information which may only affect a few pixels on a display screen such that the impact on the operation of the example system 110 is negligible (e.g., the severity of the error caused by extracting the poison data is low). The limited error log associated with an error of low severity will typically include a limited amount of error information including, for example: 1) information identifying the memory address (e.g., the example system memory 126) at which the poison data (e.g., poison data 124) is located; 2) information identifying the FRU that performed the data access, 3) information identifying whether the FRU associated with the error generated the poison data or simply observed the poison nature of the data (via, for example, the poison tag). In some examples, the requesting example FRU may not create and log any of the example limited error records when the severity is low. In some examples, the originating limited error log 136A is created by the example originating FRU 122A when the example poison data 124A is generated. Here, the first limited error log identifies the example originating FRU 122A as being the source of the example poison data 124.

As described above, each of the example limited error logs 136A, 136B, 136C, . . . , 136N is added to a respective one of the limited error log files 138A, 138B, 138C, . . . , 138N stored in a respective one of the example limited error log memories 140A, 140B, 140C, . . . , 140N associated with the example system 110. In some examples, two or more of the example limited error log files 138A, 138B, 138C, . . . , 138N can be stored in a same one of the example error log memories (e.g., the example originating limited error log memory 140A). In some examples, two or more the example limited error logs 136A, 136B, 136C, . . . , 136N can be stored in a same one of the example error log files 138A, 138B, 138C, . . . , 138N. As a result of the data requests performed by the example FRUs 122B, 122C, . . . 122N, the corresponding limited error logs 136A, 136B, 136C, . . . , 136N are created during the time intervening between the inception of the original poison data 126A by the example originating FRU 122A and the request for the example poison data 124 by the example data requester 134. In such instances, the example first limited error log 136A identifies the address of the example system memory 126 at which the example poison data 124 is stored; 2) information that can be used to identify the example originating FRU 122A; and 3) information indicating that the example originating FRU 122A generated the example poison data 124.

In some examples, when the example data requester 134 attempts to access the example poison data 124 located at the example system memory 126, the example error detector 118 use conventional techniques to determine whether the level of error generated by the attempt to access the example poison data 124 is sufficiently severe to warrant the generation of a complete enhanced error record (e.g., the example complete enhanced error record 116C) instead of a limited error log. In some examples, all errors caused by requests for poison data performed by any data requester (e.g., all requests that expose poison data to a software application hosted by the OS/VMM) are treated as high severity errors that warrant the generation of an enhanced error record. As a result, the example error detector 118 notifies the example first error record generator 112A that the data access operation has been attempted. As described above, in addition to notifying the example first error record generator 112A, the error detector 118 causes an example interrupt generator 142 to generate an interrupt that causes the example OS/VMM 130 to temporarily suspend operation for a duration of time not to exceed a threshold value (e.g., a prescribed maximum value). While the example OS/VMM 130 is halted, the example first error record generator 112A constructs the example complete enhanced error record 116C and causes the example complete enhanced error record 116C to be stored in the memory 117C. As described above, the example first error record generator 112A collects information from the example registers 135 and the example limited error logs 136A, 136B, 136C, . . . , 136N to construct the example complete enhanced error record 116C.

In some examples the limited error log files 138A-138N are only a subset of all of the limited error logs generated system-wide. In such examples, the limited error logs may contain limited error logs documenting many of the errors associated with attempts to access different instances of poison data in the system 110 and documenting all uncorrected errors generated in response to any number of system malfunctions. As a result, the number of error logs to be scanned can be quite large. In some examples, to generate the example complete enhanced error record 116C, the example first error record generator 112A scans all of the limited error logs, including the example limited error log files 138A, 138B, 138C, 138D, 138N, and retrieves all of the relevant example limited error logs (e.g., 136A-136N). In some examples, the relevant example limited error logs include all of the limited error logs that identify the memory location at which the poison data is stored (e.g., the system memory 126). Upon retrieving the relevant limited error logs (e.g., the example limited error logs 136A-136N), the example first error record generator 112A reviews the contents of each to identify or infer the example limited error log 136A, and, from that, to compute the identity of the FRU that generated the poison data (e.g., the example originating FRU 122A). Depending on the number of error record logs to be scanned, identifying the example originating FRU 122A can be a time consuming process. Generally, the number of generated error logs increases with time such that the longer the interval of time occurring between the creation of the poison data 124 and the attempted access of the poison data by the data requester 124, the greater the volume of error logs to be scanned. As described previously, in some examples where the subset of error logs created is not complete, identifying the example originating FRU 122A can become an even more time consuming process.

In some examples, the example first error record generator 112A then includes the identity of the example originating FRU 122A in the example complete enhanced error record 116C. In some examples, none of the relevant example limited error logs identifies an originating FRU and the example first error record generator 112A specifies, in the example complete enhanced error record 116C, that the poison data was generated by a device external to the system 110 such that the source of the poison data is not identifiable.

After the example complete enhanced error record 116C is constructed, the example first error record generator 112A causes the OS/VMM 130 to resume operation and identifies the example complete enhanced error memory location 117C at which the example complete enhanced error record 116C is stored to the example error handler 132. The example error handler 132 of the OS/VMM 130 accesses the example complete enhanced error record 116C and uses the example complete enhanced error record 116C to alert the example data requester 134 that the data being accessed (e.g., the poison data 124) is poison data. In addition, the example error message generator 222 generates an example error message in response to which any number of remedial action(s) may be performed as described above.

In some examples, the amount of time needed to construct the example complete enhanced error record 116C can exceed one or more threshold value(s) of time. For example, the amount of time needed to scan the limited error logs, retrieve the relevant limited error logs and identify the example originating FRU 122A can exceed the threshold value of time. In such examples, the example first error record generator 112A determines that the example complete enhanced error record 116C is to be constructed and supplied to the error handler 132 on a deferred basis (i.e., will be available at a later time) and further causes the example first signal to be transmitted to the error handler 132. The example first signal notifies the example error handler 132 that an additional amount of time is needed to construct the example complete enhanced error record 116C. In response to the example first signal, the example error handler 132 waits the specified additional amount of time before attempting to access or use the yet-to-be-constructed example complete enhanced error record 116C. During the specified additional amount of time, the example first error record generator 112A continues to scan the limited error log files 138A-138N and retrieve the relevant example limited error logs 136A-136N associated with the previous attempts to access the poison data 134 to collect the information needed to construct the example complete enhanced error record 116C.

In some examples, when the amount of time needed to construct the example complete enhanced error record 116C will exceed the threshold value of time, the example first error record generator 112A, creates the example partial enhanced error record 116P for access by the error handler 130. In such examples, the example first error signal can indicate that the example partial enhanced error record 116P is available for usage by the example error handler 132. The example first signal can further specify the additional amount of time needed to supplement the example partial enhanced error record with additional information to thereby construct the example complete enhanced error record 116C. In some examples, the example first signal informs the example error handler 132 that an example second signal will be transmitted to the example error handler 132 when the example complete enhanced error record 116C has been fully constructed. The example error handler 132, upon receiving the example second signal, accesses the example complete enhanced error record 116C. In some examples, the example first signal includes or otherwise provides the error handler 130 with information identifying the example partial enhanced error record memory 117P at which the example partial enhanced error record 116P is stored. Thus, unlike conventional error record generators that may fail to provide any enhanced error record or provide an incomplete enhanced error record when the amount of time needed to construct the error record will exceed the threshold amount of time, the example error record generator 112A provides the partial error record 116P to the error handler 132 (within the threshold amount of time) and then proceeds to construct the example complete error record 116C. The error handler 132 can then use the example complete error record 116C to identify the source of the poison data 124 and take measures to address (e.g., replace or otherwise prohibit usage of) the originating FRU 122A that caused the poison data 124 to be generated.

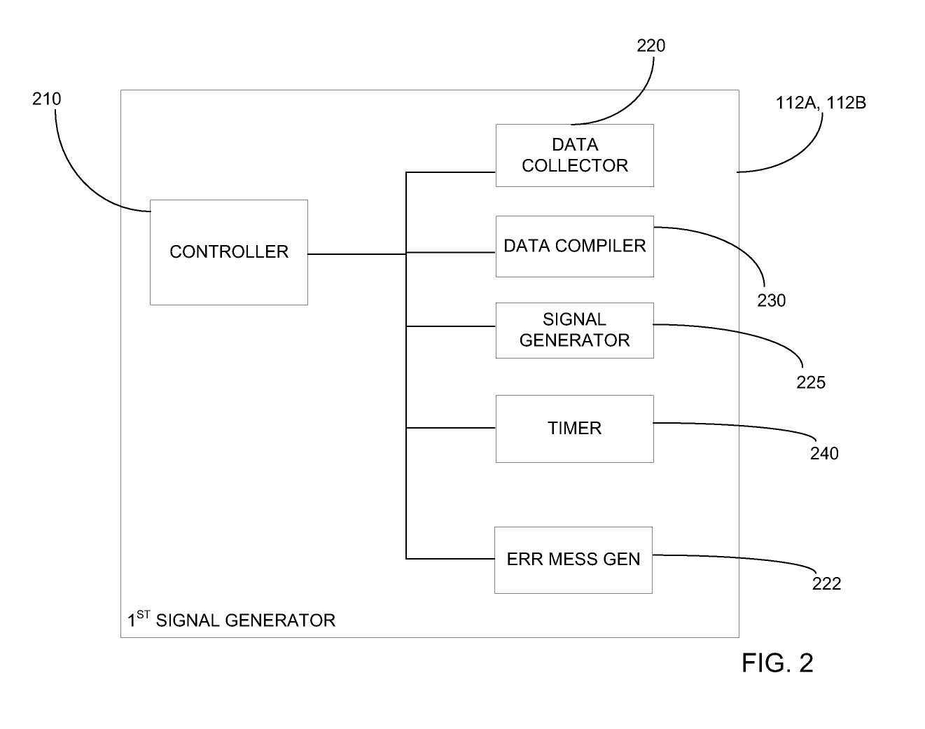

Example components that can be used to implement the example first error record generator 112A are illustrated in FIG. 2. As described above and illustrated in FIG. 1, the example error detector 118 causes the example interrupt generator 142 to halt operation of the OS/VMM 130 and notifies the first error record generator 112A when the attempt to access the example poison data 124 in the example system memory 126 is detected. An example controller 210 of the first error record generator 112A responds to the notification by causing an example data collector 220 to begin collecting error information associated with the attempt to access the poison data 124. If the example controller 210 determines that the error information needed to construct the example complete enhanced error record 116C cannot be collected within the threshold amount of time, the example controller 210 causes an example error signal generator 225 to generate the first example signal. In some examples, the example controller 210 determines that additional time is needed, because the threshold duration of time has been reached, but the identity of the originating FRU 122 has not yet been determined. In some examples, the first signal is accompanied by the partial enhanced error record 116P which is created by an example data compiler 230. In such examples, the partial enhanced error record 116P indicates to the error handler 132 that the complete enhanced error record 116C will be supplied at a later time. As described above, in some examples, the partial enhanced error record 116P identifies the example complete enhanced error record memory 116C at which the complete enhanced error record 116C will later be stored. As described above, the example first signal (e.g., the example partial enhanced error record 116P) can also identify an additional amount of time needed to construct the example complete enhanced error record 116C.

During the additional amount of time allocated by the example controller 210, the example data collector 230 continues to collect error information associated with the poison data 124 to obtain source information (e.g., the identity of the example originating FRU 122A) needed to construct the example complete enhanced error record 116C. As described above, the example data collector 230 can obtain source information by scanning the example limited error logs 138A-138N. The example controller 210 then causes the example data compiler 230 to update the example partial enhanced error record 116P with the information identifying the example originating FRU 122A to thereby construct the example complete enhanced error record 116C.

When the example complete enhanced error record 116C is constructed, the controller 210 causes the example error signal generator 225 to generate the second signal notifying the error handler 132 that the complete enhanced error record 116C is available. In some examples, the controller 210 causes the error signal generator 225 to transmit the second signal after the additional amount of time has elapsed as measured by an example timer 240.

Upon receiving the second signal, the example error handler 130 accesses the example complete enhanced error record memory 117C to retrieve the example newly constructed complete enhanced error record 116C having the identity of the example originating FRU 122A (or information that can be used to identify the example originating FRU 122A) contained therein. In some examples, the second signal is implemented as a benign interrupt (e.g., an interrupt that will not halt system operation) that is communicated via a scalable coherent interface (SCI) or a corrected machine check error interrupt communication channel. The example error handler 132 uses the information contained in the example complete enhanced error record 116C to identify one or more remedial actions to be taken to correct the error and/or otherwise repair the source of the error (e.g., the example originating FRU 122A) and can use any known technique to respond to the example enhanced error record 116. In some examples, the message generator 220 generates an error message informing the example data requester 134 that the data requested is poison data 124 and further notifying service personnel that the example originating FRU 122A is in need of repair and/or replacement.

In some examples, the example data collector 220 can continue to collect information (e.g., scan the example limited error record logs 138A-138N) during subsequently generated interrupts occurring at intervals long enough to avoid adverse impact on the operation of the example system 110. In some examples, the SMM 114 signals the example second error generator 112B of the platform firmware component 115 executing in parallel with the example SMM 114 to perform the scanning operations performed by the example first error record generator 112A when additional time is required to construct the example complete enhanced error record 116C. In some examples, the example second error record generator 112B can include the same or a subset of the components included in the example first error record generator 112A of the example SMM 114. The example second record generator 112B of the example platform firmware component 115 notifies the example first record generator 112A of the example SMM 114 when the example complete enhanced error record 116C is available and the example first error record generator 112A responds to the notification by transmitting the second signal to the example error record handler 132 indicating that the example complete enhanced error record 116C is available.

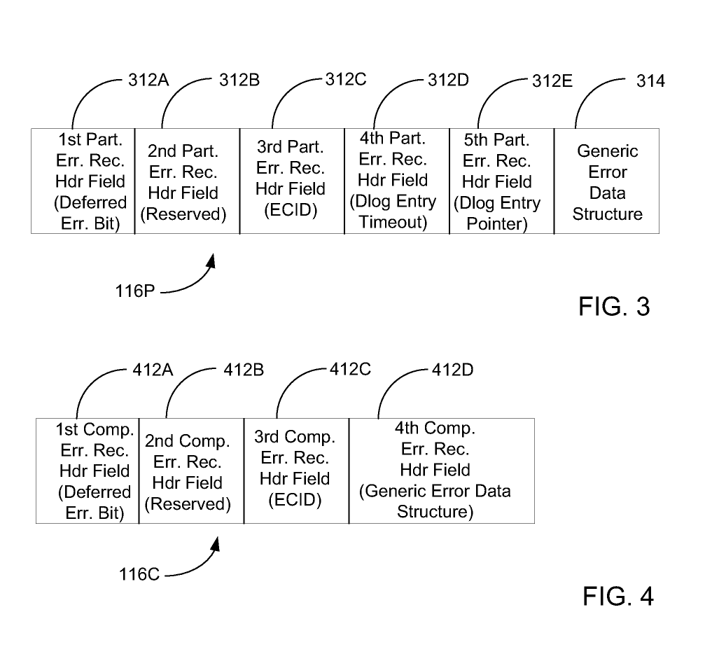

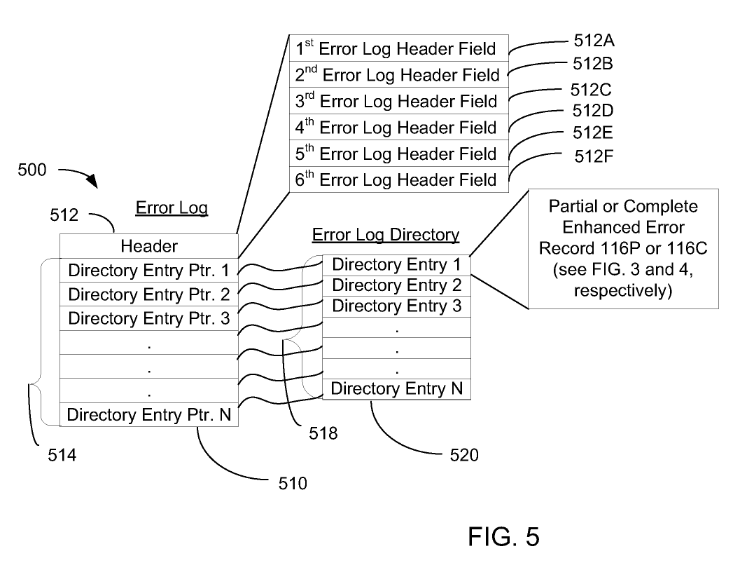

The example partial enhanced error record 116P is illustrated in FIG. 3. As described above, when the amount of time needed to construct the example complete enhanced error record 116C exceeds the threshold duration, the example first error record generator 112A supplies the example first signal to the example error handler 132 indicating that the example complete enhanced error record 116C will be supplied on a deferred basis. In some examples, the first signal is implemented using the partial enhanced error record 116P. The example partial enhanced error record 116P can include a set of example partial enhanced error record header fields 312A-312E (e.g., a first partial error record header field 312A, a second partial error record header field 312B, a third partial error record header field 312C, a fourth partial error record header field 312D and a fifth partial error record header field 312E) that indicate that the example first error record generator 112A will supply the example complete enhanced error record 116C to the example error handler 132 at a later time (e.g., on a deferred basis). In some examples, the partial enhanced error record 116P also includes a generic example partial enhanced error record header field 314 that includes (or provides information sufficient to locate) a generic error data structure (or information that can be used to locate a generic error data structure) described in greater detail below.

Referring still to FIG. 3, in some examples, the first partial error record header field 312A contains a deferred error bit that, when set, indicates that the example complete enhanced error record 116C will be deferred. If the deferred error bit is not set, the example complete enhanced error record 116C is currently available. In some examples, the second partial error record header field 312B is a place holder reserved for future use. In some examples, the third partial error record header field 312C can contain an error context identifier (ECID) that is used by the error handler 132 to correlate the example partial enhanced error record 116P with the later-supplied example complete enhanced error record 116C. To enable this correlation, the later-supplied example complete enhanced error record 116C will include the same ECID as the corresponding, earlier supplied partial enhanced error record 116P. The ECID prevents the example complete enhanced error record 116C from being mistakenly associated with a newly detected error rather than the corresponding previously detected error associated with the corresponding earlier-supplied partial enhanced error record 116P.

In some examples, the fourth partial error record header field 312D contains a deferred error log(DLog) entry timeout value that specifies a time after which the complete enhanced error record 116C will be available to the error handler 132. As described above, the example error handler 132 retrieves the example complete enhanced error record 116C after waiting the additional amount of time specified in the example fourth partial error record header field 312D or until after receiving the example second signal from the example first error record generator 112A. In some examples the fifth partial error record header field 312E contains a Dlog entry pointer that specifies a physical system address (e.g., the system memory 117C) at which the complete enhanced error record 116C will later be stored.

As described above, the example partial enhanced error record 116P can also include the partial error record generic error data structure 314 (or information sufficient to locate the generic error data structure). The generic error data structure contains the example complete enhanced error record 116C provided that the example complete enhanced error record 116C is currently available (i.e., will not be deferred). Thus, if the deferred error bit in the example first enhanced error record header field 312A is not set, the example error handler 132 can access the generic error data structure 314 to obtain the example complete enhanced error record 116C without delay. Otherwise, the example error record handler 132 waits the additional amount of time specified by the Dlog entry timeout value of the example fourth partial error record header field 312D before accessing the information contained in the generic error data structure 314. In some examples, the generic error data structure 314 can conform to a commonly used error record format such as, for example, the format defined in the Unified Extensible Firmware Interface (UEFI) specification. In some examples, the defined format can include a field containing the identity of the example originating FRU 122A.

The example complete enhanced error record 116C is illustrated in FIG. 4. As described above, after the example second signal is transmitted to the example error handler 132 (or after the example error handler 132 has waited an amount of time equal to the timeout value stored in the example fourth partial error record header field 312D (see FIG. 3)), the example error handler 132 accesses the example complete enhanced error record 116C located at the address 117C specified in the example DLog entry pointer contained in the example fifth partial error record header field 312E (see FIG. 3). In some examples, the complete enhanced error record 116C includes a set of complete enhanced error record header fields 412A-412D including an example first complete enhanced error record header field 412A, an example second complete enhanced error record header field 412B, an example third complete enhanced error record header field 412C, an example fourth complete enhanced error record header field 412D. The example first complete enhanced error record header field 412A can contain a deferred error record bit that, if set, indicates that the example complete enhanced error record 116C being accessed has been supplied on a deferred basis. The example second complete enhanced error record header field 412B can be reserved for future use and the example third complete enhanced error record field 412C can contain the ECID (also stored in the example third partial error record header field 312C (see FIG. 3). The ECID contained in the example third complete enhanced error record header field 412C is used to correlate the example complete enhanced error record 116C to the corresponding (earlier-supplied) partial enhanced error record 116P. The example fourth complete enhanced error record header field 412D can contain the generic error data structure (or information that can be used to locate the generic error data structure). As described above, the example complete enhanced error record 116C has been enhanced to identify the example originating FRU 122A. In some examples, the generic error data structure can conform to a commonly used error record format such as, for example, the format defined in the Unified Extensible Firmware Interface (UEFI). In some examples, the defined format can include a field containing the identity of the example originating FRU 122A.

Referring to FIG. 5, the example partial and complete enhanced error records 116P, 116C can be located using an example error log directory structure 500. The example error log directory structure 500 can include an error log 510 having an error log header 512 and pointers 514. In some examples, each pointer 514 in the error log 510 identifies (points to) an entry 518 in an example error log directory 520. The entries 518 in the error log directory 520 each correspond to one of the partial and/or complete enhanced error records 116P, 116C described above. In some examples, the error log header 512 associated with the error log 510 can include any number of fields that can contain information including an error log header version 512A, an error log header length 512B, a directory length 512C, an error log directory base 512D, an error log directory length 512E, and a value 512F identifying the number of example error log directory entries 518 permitted for the example system 110, and one or more other fields can be reserved for future use. The example error log header version 512A identifies a version number of an example error logging format to which the example complete enhanced error record complies. The example error log header length 512B identifies a number of bits in the error log header 512, the directory length 512C identifies a length of the error log 510, the example error log directory base 512D identifies the memory location at which a first of the entries 518 in the example error log directory 520 is located and the error log directory length 510E identifies an example number of example entries 518 in the example error log directory 520. Each of the example entries 518 in the error log directory 520 corresponds to a different one of the partial/complete enhanced error records 116P, 116C.

While examples of the system 110 have been illustrated in FIGS. 1-5, one or more of the elements, processes and/or devices illustrated in FIGS. 1-5 may be combined, divided, re-arranged, omitted, eliminated and/or implemented in any other way. Further, any or all of the example first error record generator 112A, the example second error record generator 112B, the example first system management mode component (SMM) 114, the example platform firmware component 115, the example complete enhanced error record 116C, the example partial enhanced error record 116P, the example complete enhanced error record memory 117C, the example partial enhanced error record memory 117P, the example error detector 118, the example system hardware platform 120, the example originating FRU 122A, the example first FRU 122B, the example second FRU 122C, the example nth FRU 122N, the example poison data 124, the example system memory 126, the example OS/VMM 130, the example error handler 132, and the example data requester 134, the example hardware registers 135, the example error message generator 222, the example originating limited error record 136A, the example first limited error record 136B, the example second limited error record 136C, the example nth limited error record 136N, the example originating limited error log 138A, the example first limited error log 138B, the example second limited error log 138C, the example nth limited error log 138N, the example originating limited error log memory 140A, the example first limited error log memory 140B, the example second error log memory 140C, and the example nth error log memory, the example controller 210, the example data collector 220, the example error signal generator 225, the example data compiler 230, the example partial enhanced error record header fields including the example first partial error record header field 312A, the example second partial error record header field 312B, the example third partial error record header field 312C, the example fourth partial error record header field 312D and the example fifth partial error record header field 312E, the generic structure example error log header field 314, the example first complete enhanced error record header field 412A, the example second complete enhanced error record header field 412B, the example third complete enhanced error record header field 412C, the example fourth complete enhanced error record header field 412D, the example error log directory structure 500, the example error log 510, the example error log header 512 including the example error log header version 512A, the example error log header length 512B, the example directory length 512C, the example error log directory base 512D, the example error log directory length 512E, and the example number of permitted directory entries per system 512F, the example pointers 514, the example entries 518, and the example error log directory 520 may be implemented by hardware, software, firmware and/or any combination of hardware, software and/or firmware. Thus, for example, any of the example first error record generator 112A, the example second error record generator 112B, the example first system management mode component (SMM) 114, the example platform firmware component 115, the example complete enhanced error record 116C, the example partial enhanced error record 116P, the example complete enhanced error record memory 117C, the example partial enhanced error record memory 117P, the example error detector 118, the example system hardware platform 120, the example originating FRU 122A, the example first FRU 122B, the example second FRU 122C, the example nth FRU 122N, the example poison data 124, the example system memory 126, the example OS/VMM 130, the example error handler 132, and the example data requester 134, the example hardware registers 135, the example error message generator 222, the example originating limited error record 136A, the example first limited error record 136B, the example second limited error record 136C, the example nth limited error record 136N, the example originating limited error log 138A, the example first limited error log 138B, the example second limited error log 138C, the example nth limited error log 138N, the example originating limited error log memory 140A, the example first limited error log memory 140B, the example second error log memory 140C, and the example nth error log memory, the example controller 210, the example data collector 220, the example error signal generator 225, the example data compiler 230, the example partial enhanced error record header fields including the example first partial error record header field 312A, the example second partial error record header field 312B, the example third partial error record header field 312C, the example fourth partial error record header field 312D and the example fifth partial error record header field 312E, the example partial enhanced error record header field 314 containing the generic error record structure, the example first complete enhanced error record header field 412A the example second complete enhanced error record header field 412B, the example third complete enhanced error record header field 412C, the example fourth complete enhanced error record header field 412D, the example error log directory structure 500, the example error log 510, the example error log header 512 including the example error log header version 512A, the example error log header length 512B, the example directory length 512C, the example error log directory base 512D, the example error log directory length 512E, and the example number of permitted directory entries per system 512F, the example pointers 514, the example entries 518, and the example error log directory 520 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus claims of this patent are read to cover a purely software and/or firmware implementation, at least one of the example compiler, the example analyzer component, the example code generator component and the example code executor are hereby expressly defined to include a tangible computer readable medium such as a (memory, digital versatile disk (DVD), compact disk (CD), etc.), storing such software and/or firmware. Further still, the example first error record generator 112A, the example second error record generator 112B, the example first system management mode component (SMM) 114, the example platform firmware component 115, the example complete enhanced error record 116C, the example partial enhanced error record 116P, the example complete enhanced error record memory 117C, the example partial enhanced error record memory 117P, the example error detector 118, the example system hardware platform 120, the example originating FRU 122A, the example first FRU 122B, the example second FRU 122C, the example nth FRU 122N, the example poison data 124, the example system memory 126, the example OS/VMM 130, the example error handler 132, and the example data requester 134, the example hardware registers 135, the example error message generator 222, the example originating limited error record 136A, the example first limited error record 136B, the example second limited error record 136C, the example nth limited error record 136N, the example originating limited error log 138A, the example first limited error log 138B, the example second limited error log 138C, the example nth limited error log 138N, the example originating limited error log memory 140A, the example first limited error log memory 140B, the example second error log memory 140C, and the example nth error log memory, the example controller 210, the example data collector 220, the example error signal generator 225, the example data compiler 230, the example partial enhanced error record header fields 312A-312E including the example first partial error record header field 312A, the example second partial error record header field 312B, the example third partial error record header field 312C, the example fourth partial error record header field 312D and the example fifth partial error record header field 312E, the example partial enhanced error record header field 314 containing the generic error record structure, the example first complete enhanced error record header field 412A the example second complete enhanced error record header field 412B, the example third complete enhanced error record header field 412C, the example fourth complete enhanced error record header field 412D, the example error log directory structure 500, the example error log 510, the example error log header 512 including the example error log header version 512A, the example error log header length 512B, the example directory length 512C, the example error log directory base 512D, the example error log directory length 512E, and the example number of permitted directory entries per system 512F, the example pointers 514, the example entries 518, and the example error log directory 520 of FIGS. 1-5 may include one or more elements, processes and/or devices in addition to, or instead of, those illustrated in FIGS. 1-5 and/or may include more than one of any or all of the illustrated elements, processes and devices.

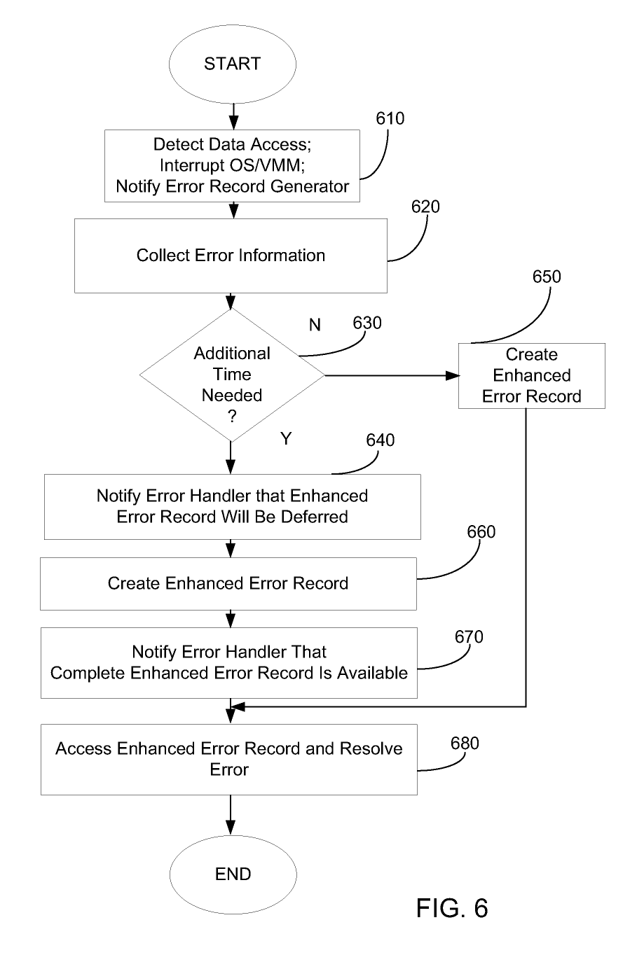

A flowchart representative of example machine readable instructions that may be executed to implement the example first error record generator 112A, the example second error record generator 112B, the example first system management mode component (SMM) 114, the example platform firmware component 115, the example complete enhanced error record 116C, the example partial enhanced error record 116P, the example complete enhanced error record memory 117C, the example partial enhanced error record memory 117P, the example error detector 118, the example system hardware platform 120, the example originating FRU 122A, the example first FRU 122B, the example second FRU 122C, the example nth FRU 122N, the example poison data 124, the example system memory 126, the example OS/VMM 130, the example error handler 132, and the example data requester 134, the example hardware registers 135, the example error message generator 222, the example originating limited error record 136A, the example first limited error record 136B, the example second limited error record 136C, the example nth limited error record 136N, the example originating limited error log 138A, the example first limited error log 138B, the example second limited error log 138C, the example nth limited error log 138N, the example originating limited error log memory 140A, the example first limited error log memory 140B, the example second error log memory 140C, and the example nth error log memory, the example controller 210, the example data collector 220, the example error signal generator 225, the example data compiler 230, the example partial enhanced error record header fields including the example first partial error record header field 312A, the example second partial error record header field 312B, the example third partial error record header field 312C, the example fourth partial error record header field 312D and the example fifth partial error record header field 312E, the example partial enhanced error record header field 314 containing the generic error record structure, the example first complete enhanced error record header field 412A the example second complete enhanced error record header field 412B, the example third complete enhanced error record header field 412C, the example fourth complete enhanced error record header field 412D, the example error log directory structure 500, the example error log 510, the example error log header 512 including the example error log header version 512A, the example error log header length 512B, the example directory length 512C, the example error log directory base 512D, the example error log directory length 512E, and the example number of permitted directory entries per system 512F, the example pointers 514, the example entries 518, and the example error log directory 520 of FIGS. 1-5 are shown in FIG. 6. In this example, the machine readable instructions represented by each flowchart may comprise one or more programs for execution by a processor, such as the example processor 812 shown in the example processing example system 800 discussed below in connection with FIG. 8. Alternatively, the entire program or programs and/or portions thereof implementing one or more of the processes represented by the flowchart of FIG. 6 could be executed by a device other than the example processor 812 (e.g., such as an example controller and/or any other suitable device) and/or embodied in firmware or dedicated hardware (e.g., implemented by an ASIC, a PLD, an FPLD, discrete logic, etc.). Also, one or more of the blocks of the flowchart of FIG. 6 may be implemented manually. Further, although the example machine readable instructions are described with reference to the flowchart illustrated in FIG. 6, many other techniques for implementing the example methods and apparatus described herein may alternatively be used. For example, with reference to the flowchart illustrated in FIG. 6 the order of execution of the blocks may be changed, and/or some of the blocks described may be changed, eliminated, combined and/or subdivided into multiple blocks.

As mentioned above, the example processes of FIG. 6 may be implemented using coded instructions (e.g., computer readable instructions) stored on a tangible computer readable storage medium such as a hard disk drive, a flash memory, a read-only memory (ROM), a CD, a DVD, a cache, a random-access memory (RAM) and/or any other storage device and/or storage disk in which information is stored for any duration (e.g., for extended time periods, permanently, brief instances, for temporarily buffering, and/or for caching of the information). As used herein, the term tangible computer readable storage medium is expressly defined to include any type of computer readable storage and to exclude propagating signals. Additionally or alternatively, the example processes of FIG. 6 may be implemented using coded instructions (e.g., computer readable instructions) stored on a non-transitory computer readable storage medium, such as a flash memory, a ROM, a CD, a DVD, a cache, a random-access memory (RAM) and/or any other storage media in which information is stored for any duration (e.g., for extended time periods, permanently, brief instances, for temporarily buffering, and/or for caching of the information). As used herein, the term non-transitory machine readable medium is expressly defined to include any type of machine readable storage medium and to exclude propagating signals. Also, as used herein, the terms “computer readable” and “machine readable” are considered equivalent unless indicated otherwise. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

Example machine readable instructions 600 that may be executed to implement the example first error record generator 112A and/or the example second error record generator 112B of FIG. 1 are illustrated using the flowchart shown FIG. 6. The example machine readable instructions 600 may be executed at intervals (e.g., predetermined intervals), based on an occurrence of an event (e.g., a predetermined event, etc.), or any combination thereof. In this example, the instructions 600 begin when the example error detector 118 (see FIG. 1) detects an attempt to access the example poison data 124, suspends operation of the example OS/VMM 130 and notifies the example first error record generator 112A that the example partial and/or complete enhanced error record 116P/116C is to be generated (block 610). The example first error record generator 112A responds by collecting error information (e.g., information from the registers 135 and the limited error record logs 138A-138N) (block 620) and determines whether additional time is needed to construct the example complete enhanced error record 116C (block 630). The example first error record generator 112A notifies the example error handler 132 if additional time is needed to construct the example complete enhanced error record 116C (block 640). In some examples, the example first error record generator 112A notifies the error handler by constructing the example partial enhanced error record 116P and providing information about the location of the example partial enhanced error record 116P to the example error handler 132. If additional time is not needed (block 630), the example first error record generator 112A generates the example complete enhanced error record 116C within the maximum prescribed duration of time (block 650). If additional time is needed (block 630), the example first and/or the example second error record generator(s) 112A/112B continue to collect error information (e.g., scan/review the limited error record logs generated by the system 110, (e.g., the example limited error record logs 136A-136N), generated in response to respective requests for the example poison data 124 to obtain the identity of the example originating FRU 122A. The collected information is used to construct the example complete enhanced error record 116C (block 660). The example first error record generator 112A notifies the example error handler 132 that the example complete enhanced error record 116C has been constructed (block 670) and the example error handler 132 accesses the example complete enhanced error record 116C for use in resolving the error (block 680), and, in some examples, the example error message generator 222 generates an error message.

As described above, in some examples, the example first error record generator 112A notifies the example error handler 132 that the example complete enhanced error record 116C will be deferred as described with respect to the block 640 by sending the example first signal. In some examples, the example first signal is created by setting the example partial enhanced error record header fields 312A-312D of the example partial enhanced error record 116P. In such examples, the example first signal identifies the memory location 117B at which the example partial enhanced error record 116P is stored. Upon receiving the example first signal, the example error handler 132 accesses the memory location 117B and thereby determines that the example complete enhanced error record 116C will be supplied/constructed at a later time (e.g., checks whether the deferred error bit has been set). In some examples, if the deferred bit has been set, the example error handler 132 records the ECID and Dlog pointer supplied in the example third and fifth fields 312C, 312E of the example complete enhanced error record header 412 (see FIG. 4) respectively. In some examples, the example error record handler 132 waits for an example second signal from the example first error record generator 112A or the example error record handler 132 causes an example second timer 144 (see FIG. 1) to fire after an amount of time equal to the timeout value of the example fourth header field 412 has expired and responds to the timer-generated signal by processing the example complete enhanced error record 116C.

If the example first error record generator 112A does not need to defer creation of the example complete enhanced error record 116C such that example complete enhanced error record 116C will not be supplied/constructed on a deferred basis, and the example first error record generator 112A constructs the example complete enhanced error record 116C within the prescribed maximum duration of time.

The system 700 of the instant example includes a processor 712. For example, the processor 712 can be implemented by one or more microprocessors and/or controllers from any desired family or manufacturer.

The processor 712 includes a local memory 713 (e.g., a cache) and is in communication with a main memory including a volatile memory 714 and a non-volatile memory 716 via a bus 718. The volatile memory 714 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processing system 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, a trackbar (such as an isopoint), a voice recognition system and/or any other human-machine interface.

One or more output devices 724 are also connected to the interface circuit 720. The output devices 724 can be implemented, for example, by display devices (e.g., a liquid crystal display, a cathode ray tube display (CRT)), a printer and/or speakers. The interface circuit 720, thus, typically includes a graphics driver card.

The interface circuit 720 also includes a communication device, such as a modem or network interface card, to facilitate exchange of data with external computers via a network 726 (e.g., an Ethernet connection, a digital subscriber line (DSL), a telephone line, coaxial cable, a cellular telephone system, etc.).

The processing system 700 also includes one or more mass storage devices 728 for storing machine readable instructions and data. Examples of such mass storage devices 728 include floppy disk drives, hard drive disks, compact disk drives and digital versatile disk (DVD) drives.

In some examples, the mass storage device 730 may implement the memories 126, 140A-140N, 117P, 117C, and system memory 126 residing in the system 110 and/or may be used to implement the example error directory structure 600 for the example partial and/or complete enhanced error records 116P, 116C, and the example partial and/or complete enhanced error record memories 117P, 117C. Additionally or alternatively, in some examples the volatile memory 718 may implement one or more of the limited error record memories 140A-140N, the system memory 126, and the partial and/or complete enhanced error record memories 117P, 117C.

Coded instructions 732 corresponding to the instructions of FIG. 6 may be stored in the mass storage device 728, in the volatile memory 714, in the non-volatile memory 716, in the local memory 713 and/or on a removable storage medium, such as a CD or DVD 736.

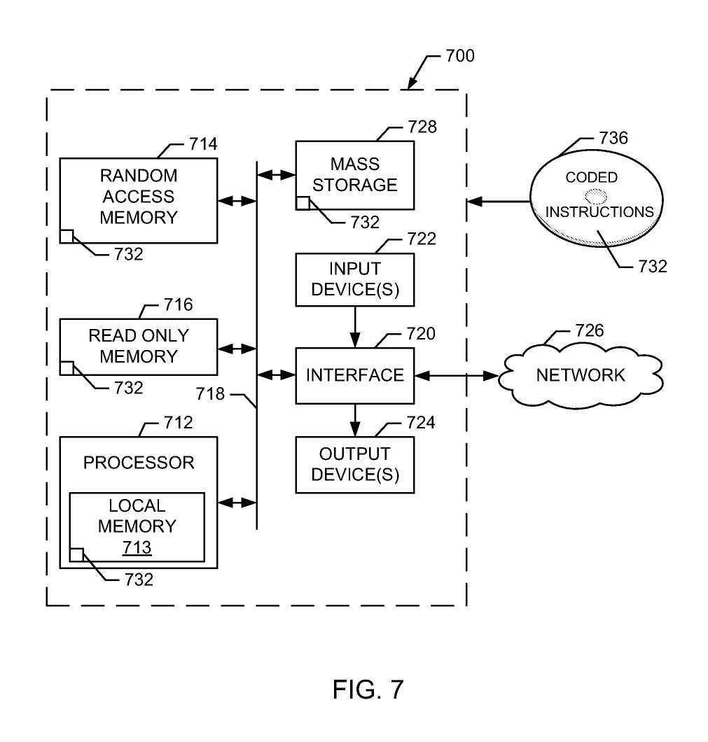

As an alternative to implementing the methods and/or apparatus described herein in a system such as the processing system of FIG. 7, the methods and or apparatus described herein may be embedded in a structure such as a processor and/or an ASIC (application specific integrated circuit).

One example method disclosed herein performing a scan of one or more error logs to identify a source of data in response to an attempt to access the data, determining whether an amount of time to complete the scan will exceed a threshold value, and generating a notice that the error record will be deferred based on the determination. In some examples, generating the notice indicates a time at which the error record will be available and a location at which the error record will be stored and, in some examples, the notice is a first notice indicating that a second notice will be generated when the error record has been constructed.

In other methods, the notice indicates a location at which a partial error record will be stored and the method includes generating the error record by supplementing the partial error record with source identifying information. In some examples, a first error record generator generates the partial error record and a second error record generator generates a second signal indicating that the error record has been generated. The partial error record can include a field containing a bit and the bit is set when the error record is to be deferred. In some examples, the partial error record includes a field containing information to correlate the partial error record with the error record.

In some example methods, the notice generated to indicate that an error record will be deferred is a first notice generated by a first error record generator and the method can additionally include causing a second error record generator to generate the error record after the threshold value has been exceeded, causing the second error record generator to generate a second notice indicating that the error record is available and causing the first error record generator to generate a third notice indicating that the error record has been generated, the third notice being transmitted to an error handler. The second notice can be transmitted to the first error record generator

In some examples, the method additionally includes generating the error record after the threshold value has been exceeded and generating a second notice that the error record has been generated.

In some of the examples disclosed herein an apparatus is used to generate an error record and the apparatus includes a data collector to scan an error log to identify a source of data in response to an attempt to access the data, a controller to determine whether an amount of time to scan the one or more error logs to identify the source of data will exceed a threshold value, and a signal generator to generate a signal indicating that the error record is to be deferred based on the determination. In some examples the signal is a first signal and the signal generator generates a second signal indicating that the error record has been generated or the first signal can indicate that a second signal will be generated, the second signal indicating that the error record has been generated.

In some examples the apparatus also includes a data compiler to generate the error record by adding source identifying information to a partial error record. In some examples the signal indicates a location at which a partial error record is stored, and the partial error record indicates a location at which the error record will be stored. In some examples the apparatus is to create the error record by supplementing the partial error record with source identifying information. In some examples, the partial error record includes a deferred bit that is set when the error record is to be deferred or the partial error record includes correlation information to correlate the partial enhanced error record to the enhanced error record. In some examples, the data collector of the apparatus continues to scan the one or more error logs to identify the source after the threshold value has been exceeded. In further examples, the data collector of the apparatus is a first data collector, the signal is a first signal, and the controller of the apparatus is to further to cause the signal generator to generate a second signal where the second signal causes a second data collector to generate the error record after the threshold value has been exceeded, and the controller is further respond to a third signal generated by the second data collector, the second signal indicating to that the error record has been generated.

In some examples disclosed herein a tangible machine readable storage medium includes instructions which, when executed, cause a machine to scan one or more error logs to identify a source of data in response to an attempt to access the data, determine whether an amount of time to complete the scan will exceed a threshold value, and generate a notice that an error record will be deferred. In some examples, the notice indicates a location at which the error record will be stored. In some examples, the notice is a first notice that indicates that a second notice will be generated and the second notice indicates that the error record has been generated. In some examples, the instructions further cause the machine to generate the second signal.

In some examples, the first notice is a partial error record, and the instructions further cause the machine to generate the error record by supplementing the partial error record with information identifying the source of the data. In some examples, the instruction to scan the one or more error logs further includes instructions that cause the machine to traverse, in reverse order, one or more error logs to identify error records associated with previously generated errors, identify a subset of the error records where the subset of previously constructed error records are associated with the data, and to identify the source of the data using the previously constructed error records.

In some examples, the notice indicates a location at which a partial error record is stored, and the instruction to cause the machine to generate the notice comprises instructions that cause the machine to create the partial error record where the partial error record indicates that the error record will be available at a later time and indicates the later time at which the complete error record will be available. In some further examples, the partial error record includes a bit that is set when the error record is to be available at a later time deferred and/or the partial error record includes a correlation field containing correlation information that correlates the partial error record to the complete error record.

Finally, although certain example methods, apparatus and articles of manufacture have been described herein, the scope of coverage of this patent is not limited thereto. On the contrary, this patent covers all methods, apparatus and articles of manufacture fairly falling within the scope of the claims of the patent either literally or under the doctrine of equivalents.

What is claimed is:

1. A method to generate an error record, comprising:
performing a scan of one or more error logs to identify a source of data in response to an attempt to access the data;
determining whether an amount of time to complete the scan will exceed a threshold value; and
generating a notice that the error record will be deferred based on the determination.

2. A method as defined in claim 1 wherein generating the notice indicates a time at which the error record will be available and a location at which the error record will be stored.

3. A method as defined in claim 1 wherein the notice is a first notice indicating that a second notice will be generated when the error record has been constructed.

4. A method as defined in claim 1 wherein the notice indicates a location at which a partial error record will be stored, the method further comprising generating the error record by supplementing the partial error record with source identifying information.

5. A method as defined in claim 4 wherein a first error record generator generates the partial error record and a second error record generator generates a second signal indicating that the error record has been generated.

6. A method as defined in claim 4 wherein the partial error record comprises a bit, the method further comprising setting the bit when the error record is to be deferred.

7. A method as defined in claim 4 wherein the partial error record comprises information to correlate the partial error record with the error record.

8. A method as defined in claim 1 wherein the notice is a first notice generated by a first error record generator, the method further comprising:
causing a second error record generator to generate the error record after the threshold value has been exceeded;
causing the second error record generator to generate a second notice indicating that the error record is available, the second notice being transmitted to the first error record generator; and
causing the first error record generator to generate a third notice indicating that the error record has been generated, the third notice being transmitted to an error handler.

9. A method as defined in claim 1 wherein the notice is a first notice, the method further comprising:
generating the error record after the threshold value has been exceeded; and
generating a second notice that the error record has been generated.

10. An apparatus to generate an error record comprising:
a data collector to scan one or more error logs to identify a source of data in response to an attempt to access the data;
a controller to determine whether an amount of time to scan the one or more error logs to identify the source of data will exceed a threshold value; and
a signal generator to generate a signal indicating that the error record is to be deferred based on the determination.

11. An apparatus as defined in claim 10 wherein the signal is a first signal and the signal generator generates a second signal indicating that the error record has been generated.

12. An apparatus as defined in claim 10 wherein the signal is a first signal and wherein the first signal indicates that a second signal will be generated, the second signal indicating that the error record has been generated.

13. An apparatus as defined in claim 10 further comprising a data compiler to generate the error record by adding source identifying information to a partial error record.

14. An apparatus as defined in claim 10 wherein the signal further indicates a location at which a partial error record is stored, the partial error record indicating a location at which the error record will be stored, and the error record is created by supplementing the partial error record with source identifying information.

15. An apparatus as defined in claim 14 wherein the partial error record includes a deferred bit, the deferred bit being set when the error record is to be deferred.

16. An apparatus as defined in claim 14 wherein the partial error record includes correlation information to correlate the partial enhanced error record to the enhanced error record.

17. An apparatus as defined in claim 10 wherein the data collector continues to scan the one or more error logs to identify the source after the threshold value has been exceeded.

18. An apparatus as defined in claim 10 wherein the data collector is a first data collector, the signal is a first signal, and the controller is to further to:
cause the signal generator to generate a second signal, the second signal causing a second data collector to generate the error record after the threshold value has been exceeded, and
respond to a third signal generated by the second data collector, the second signal indicating to that the error record has been generated.

19. A tangible machine readable storage medium comprising machine readable instructions which, when executed, cause a machine to at least:
scan one or more error logs to identify a source of data in response to an attempt to access the data;
determine whether an amount of time to complete the scan will exceed a threshold value; and
generate a notice that an error record will be deferred.

20. A tangible machine readable storage medium as defined in claim 19 wherein the notice indicates a location at which the error record will be stored.

21. A tangible machine readable storage medium as defined in claim 19 wherein the notice is a first notice indicating that a second notice will be generated, the second notice indicating that the error record has been generated and the instructions further cause the machine to generate the second signal.

22. A tangible machine readable storage medium as defined in claim 21 wherein the first notice is a partial error record, the instructions further causing the machine to:
generate the error record by supplementing the partial error record with information identifying the source of the data.

23. A tangible machine readable storage medium as defined in claim 19 wherein the instruction to scan the one or more error logs comprises instructions that cause the machine to:
traverse, in reverse order, the one or more error logs to identify error records associated with previously generated errors;
identify a subset of the error records, the subset of previously constructed error records being associated with the data; and
identify the source of the data using the previously constructed error records.

24. A tangible machine readable storage medium as defined in claim 23 wherein the notice is indicates a location at which a partial error record is stored, and wherein the instruction to cause the machine to generate the notice comprises instructions that cause the machine to:
create the partial error record, the partial error record indicating that the error record will be available at a later time and indicating the later time at which the complete error record will be available.

25. A tangible machine readable storage medium as defined in claim 24 wherein the partial error record includes a bit, the bit being set when the error record is to be available at a later time.

26. A tangible machine readable storage medium as defined in claim 24 wherein the partial error record includes a correlation field containing correlation information that correlates the partial error record to the complete error record.
